(19) United States
(12) Patent Application Publication
(10) Pub. No.: US 2013/0127182 A1
(43) Pub. Date: May 23, 2013

(54) MOTOR VEHICLE LOCK

(71) Applicants: Thorsten Bendel, Oberhausen (DE); Serkan Gülkan, Hattingen (DE); Karsten Barth, Hattingen (DE); Ulrich Weichsel, Duisburg (DE)

(72) Inventors: Thorsten Bendel, Oberhausen (DE); Serkan Gülkan, Hattingen (DE); Karsten Barth, Hattingen (DE); Ulrich Weichsel, Duisburg (DE)

(21) Appl. No.: 13/638,798

(22) PCT Filed: Jan. 20, 2011
(86) PCT No.: PCT/DE2011/000053

§ 371 Date: Feb. 7, 2013

(30) Foreign Application Priority Data
Mar. 31, 2010 (DE) 10 2010 003 500.9

(51) Int. Cl. E05B 65/12

(52) U.S. Cl. CPC E05B 77/40
USPC 292/200

(57) ABSTRACT

The invention relates to a lock for a motor vehicle having a locking mechanism comprising a rotary latch, a main latching pawl and preferably a preliminary latching pawl for latching the rotary latch. The preliminary latching pawl can engage in a preliminary latching element of the rotary latch. The main latching pawl can engage in a main latching element of the rotary latch. Moreover, there is a blocking lever for blocking the main latching pawl. The blocking lever is spring-mounted in order to ensure smooth running.

The invention relates to a motor vehicle having a locking mechanism comprising a rotary latch, a main latching pawl and preferably a preliminary latching pawl for latching the rotary latch. The preliminary latching pawl can engage in a preliminary latch of the rotary latch. The resulting position is referred to as preliminary latching position. The main latching pawl can engage in a main latch of the rotary latch. The resulting position is referred to as main latching position. The rotary latch contains a fork-shaped inlet slot, into which a locking bolt of a vehicle door or of a vehicle tailgate moves when the vehicle door or tailgate is locked. The locking bolt can then turn the rotary latch from an open position into a closed position. Once the rotary latch has reached a closed position, the locking bolt can no longer leave the inlet slot of the rotary latch.

In order to prevent a pawl from unintentionally leaving the latched position, a blocking lever can be provided, blocking such a movement when the rotary latch is latched. Such a blocking lever is required in the lock disclosed in published document DE 10 2007 003 948 A1 for the main latching pawl, as the rotary latch and the main latching pawl are designed in such a way that the rotary latch can apply an opening turning moment to the main latching pawl thus allowing it to be pushed out of the latched position. This serves to ensure the quiet opening of the lock.

The not prepublished German patent application DE 10 2010 003 483 discloses a lock of the described type, containing a tappet for the main latching pawl, in order to ensure that the main latching pawl is safely lifted out of its latching position.

Published document WO 2009/149684 A1 discloses that a blocking lever can provide alternative or additional protection against break-ins for a lock.

For reasons of stability, the locking mechanism and the blocking lever are generally predominantly made of metal. Metal parts are covered at least partially in plastic in order to minimize opening and closing noises as well as frictional forces.

The invention has the task of minimizing opening and closing noises of a lock used in a motor vehicle and, in particular, with little production effort.

The task of the invention is solved by a lock with the characteristics of the first claim. Advantageous embodiments are described in the sub claims.

To solve the task, a lock for a motor vehicle contains a locking mechanism attached to the lock plate with a rotary latch, a main latching pawl and, in particular, a preliminary latching pawl for latching of the rotary latch. The main latching pawl can be blocked in the main latching position of the locking mechanism by a rotatably mounted blocking lever. In an embodiment solving the task of the invention, the blocking lever is resiliently mounted. It has been found that a particularly smooth operation can be ensured by such resilient mounting.

The blocking lever is thus not only rotatable but is, at the same time, resiliently mounted. A resilient mounting as described in the invention does not mean that a pretensioned spring acts on the blocking lever in such a way that the blocking lever can be turned around its rotation axle by the spring. Instead the resilient mounting described in the claim refers to the mounting on the axle, containing at least one spring element, so that the blocking lever can be moved against a spring force in addition to its rotational movement.

Often there are no problems as regards the smooth operation of a rotatable component of a motor vehicle door lock, so that normally no special measures are required to improve the smooth operation. Consequently, experts generally do not strive to improve the smooth operation of a blocking lever. Instead experts will only look for measures improving the smooth operation and use these if this makes sense. The present invention is based on the understanding that it can make sense to improve the smooth operation of a blocking lever and to attribute special efforts to this that exceed the normal level of effort.

The inventors found that from a technology perspective it makes sense to provide special measures for improving the smooth operation of the blocking lever when the blocking lever jumps off the main latching pawl once released, as the rotary latch applies an opening turning moment on the main latching pawl causing the main latching pawl to exert pressure on the blocking lever in the main latching position. The inventors found that from a technology perspective it makes sense to provide special measures for improving the smooth operation of the blocking lever when the center of gravity of the blocking levers has been balanced and, in particular, in the manner disclosed in published document WO 2009/150225 A2.

The lock described in the claims does therefore advantageously contain a resiliently mounted blocking lever, in particular, when the lock is designed in such a way that the rotary latch in its main latching position applies an opening turning moment onto the main latching pawl and/or the blocking lever is balanced as disclosed in patent application WO 2009/150225 A2, that is to say, contains two lever arms extending in opposite directions, when viewed from the rotation axle of the blocking lever. The blocking lever of the invention is therefore in particular designed in the manner known from WO 2009/150225 A2, unless where a deviation has been expressly specified. We therefore include the disclosure content of patent application WO 2009/150225 A2 in this application.

Additional effort is required to provide a resilient mounting for a pawl or a lever and this is also not always advantageous. Consequently, the preliminary latching pawl and the main latching pawl are generally not resiliently mounted. In particular in case of the main latching pawl it is, on the contrary, preferred for a metal area of the main latching pawl to abut directly against the metal axle, around which the main latching pawl can be rotated. As a result, a rigid, motion-free connection to the rotary latch is provided, which is advantageous for a lock in locked condition. In case of the preliminary latching pawl such a particularly rigid connection to the rotary latch is immaterial as the preliminary latching pawl does not contribute to the locking of the locking mechanism in a correctly locked lock. In case of the preliminary latching pawl, the inventors have also not found any constellation in which a particular smooth operation provided by means of a resilient mounting would have provided an overall advantage. The inventors have therefore investigated the scenario in which the dimensions of the pawl and the lever arms of the preliminary latching pawl are larger or longer than the dimensions and/or the lever arms of the blocking lever. It is therefore preferred that, in case of the preliminary latching pawl a plastic sleeve or covering separates the axle for the preliminary latching pawl from a metal area of the preliminary latching pawl without said pawl being resiliently mounted. Noise and frictional forces are in this way minimized further without having to accept other significant disadvantages.

Advantageously the blocking lever is not only resiliently mounted. One embodiment also provides a plastic sleeve or covering, separating respective metal areas of the blocking lever from its metal axle. This further minimizes noises and frictional forces.

In order to provide a resilient mounting for the blocking lever, one embodiment contains one or more resilient elements with the aid of which the blocking lever is resiliently pressed against a stop and, in particular, against a stop at one end of the axle around which the blocking lever can be turned. The resilient element or elements can, for instance, be made of plastic and are then preferably connected to the said plastic sleeve surrounding the blocking lever axle, as a single piece in order to minimize manufacturing efforts. In one embodiment, this plastic element contains planar areas, projecting vertically from the sleeve. These planar areas also connected to the sleeve as a single piece, separate the blocking lever from the lock plate in order to minimize noise and friction forces.

In order to solve the task, a lock of the type described above comprises a rotary latch with a preliminary latch formed by a protruding bolt. In the preliminary latching position, one edge of the said preliminary latching pawl rests against the bolt, causing the rotary latch to be locked. For reasons of stability, the edge consists of a metal core, which is covered by a plastic layer in order to reduce noise. Where the plastic layer extends up to a metal bolt arranged on the preliminary latching pawl and where the plastic layer covers this metal core, two different areas can be provided in a noise reducing and/or low friction design in one production step. This also achieves that the plastic layer is positively and thus reliably connected to the preliminary latch pawl. Such a proximal bolt can, for instance be of use for providing the lock with a closing aid. A closing aid moves the rotary latch into the main latching position with the aid of a motor, when the rotary latch is locked in the preliminary latching position. In this case a bow is, for instance provided, whose movement can be controlled with the aid of the said next bolt. This bow is, in particular for closing the door, advantageously steered against the bolt of the rotary latch, capturing said bolt in order to move the rotary latch into the main latching position, also forming the preliminary latch.

Polypropylene can be used as the plastic. Where not only a reduction in noise but also a reduction of frictional forces is required, specially designed plastics, such as polytetrafluorethylene are preferred.

Below the invention is explained in detail with reference to one embodiment, in which:

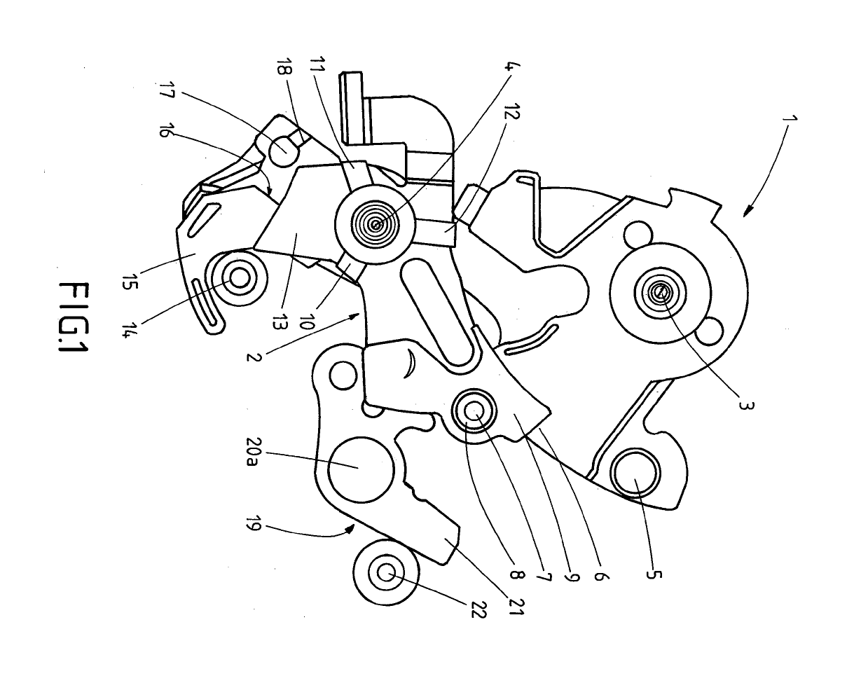

FIG. 1: shows components of a locking mechanisms viewed from the top towards the lock plate (not shown);

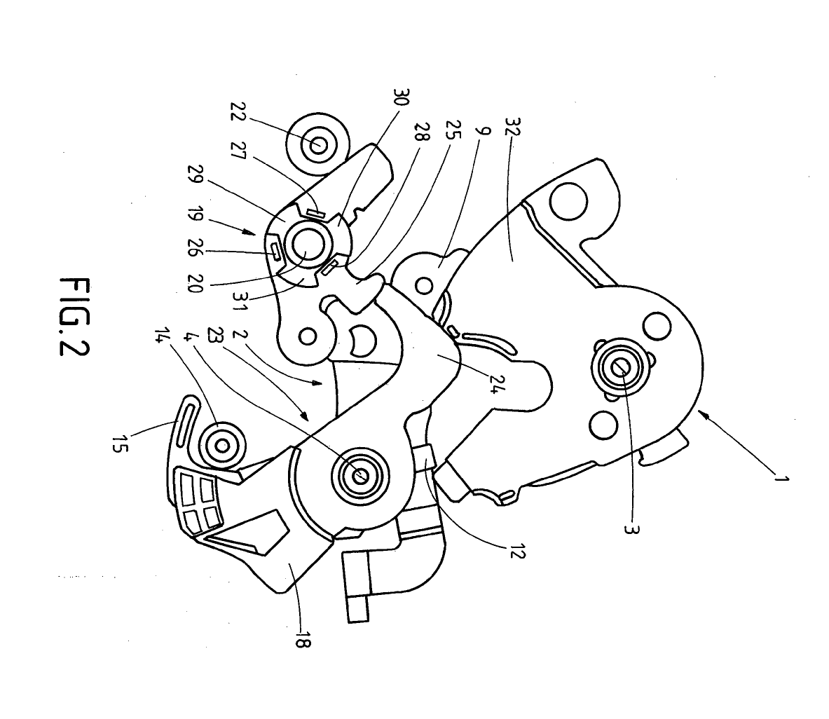

FIG. 2: shows components of a locking mechanism from FIG. 1 from underneath;

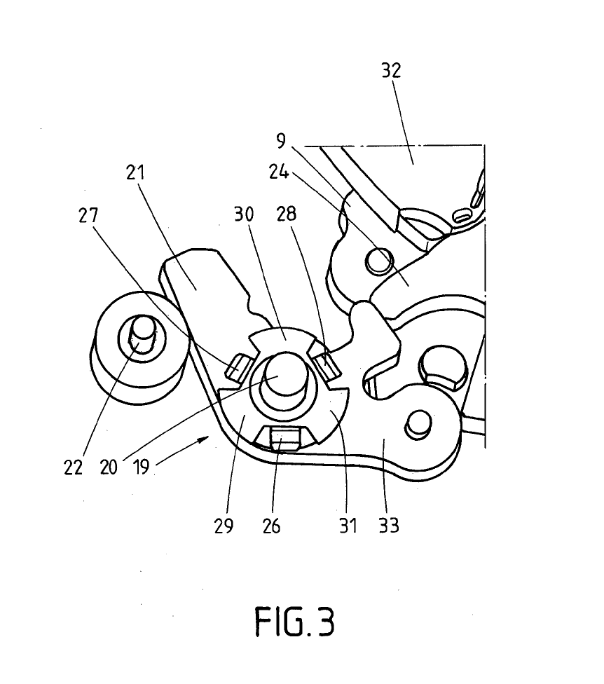

FIG. 3: shows a section of a perspective view.

FIG. 1 shows an arrangement of components of a locking mechanism. The relative arrangement of the components shown in FIG. 1 occurs in the main latching position of a lock. The locking mechanism comprises a rotary latch 1 consisting mainly of metal and a preliminary latching pawl 2 also consisting mainly of metal. The rotary latch 1 can be rotated around an axle 3. The preliminary latching pawl 2 can be rotated around an axle 4. The plane, within which the preliminary latch pawl 2 can be turned, is situated above the plane within which the rotary latch 1 can be rotated in FIG. 1.

The rotary latch 1 contains a bolt 5 protruding in the direction of the rotating plane of the preliminary latch pawl, forming the preliminary latch and which can also be part of a closing aid at the same time and, in particular, in the manner known from German patent application 102009026921.5, in order to move the rotary latch by means of a motor from the preliminary latching position into the main latching position. In the preliminary latching position of the locking mechanism the bolt 5 rests against the lateral edge 6 of the preliminary latching pawl 2, as a result of which the rotary latch 1 is prevented from being rotated into an open position. The bolt 5 attached to the rotary latch 1 is also made of metal for reasons of stability. To minimize production efforts, the bolt 5 is not covered by plastic. Instead the edge 6 is formed by a metal core covered by a noise-reducing plastic layer. The plastic layer extends to a bolt mounted on a preliminary latching pawl 2 and also covered by plastic. The bolt consists of a metal core 7 covered by plastic 8. In this way, metal areas can be covered by plastic in only one production step in order to achieve several advantageous effects. This also ensures that the plastic coating is rigidly connected with the metal area. The bolt 7, 8 mounted on the preliminary latching pawl 2 and protruding upwards out of the paper plane, serves to provide a closing aid in the manner described in the German patent application 102009026921.5. Individual or a combination of these characteristics of this closing aid can be part of this lock, provided no deviations are stipulated. By covering the bolt with plastic 8, frictional forces that occur in particular during closing by means of the closing aid, are kept to a minimum. Also frictional noises generated by the closing aid, are reduced to a minimum.

As already known from the German patent application 102009026921.5, the closing aid contains a bow arranged above the preliminary latching pawl 2 with a slotted hole into which the bolt 7, 8 arranged on the preliminary latch pawl extends. The plastic coating 9, extending amongst other things from the edge 6 up to the metal core 7, minimizes frictional forces and frictional noises that occur when the said bow of the closing aid is being moved, in order to, for instance, rotate the rotary latch 1 with the aid of a motor from the preliminary latching position into the main latching position. Again no further production step is required to provide this measure. The German patent application 102009026921.5 specifies further details about the functioning and advantages of a motor vehicle door lock, containing components shown in FIG. 1. We include the disclosure content of this patent application in the disclosure content of the present application. The present invention includes, in particular, a closing aid and arrangements disclosed in the German patent application 102009026921.5.

In order to minimize noise and frictional forces created by the turning of the preliminary latching pawl 2, the pawl contains a further plastic coating, which on one hand covers the inside of the hole like a sleeve through which axle 4 extends. On its top and its bottom side this coating merges with three ribbon-shaped plastic areas 10, 11, 12, enclosing the preliminary latching pawl. Metal parts that abut the preliminary latching pawl 2 in the area of the axle 4 from the top or bottom then rest on the surfaces of the plastic ribbons 10, 11 and 12 so that with a minimum of material and work effort rotation noises and frictional forces are minimized.

Where the rotary latch 1 is moved from an open position towards the closed position, the preliminary latching pawl 2 shown in FIG. 1 is turned anti-clockwise by a pretensioned spring when reaching the preliminary latching position, until the lever arm 13 rests against the stop 14, such as shown in FIG. 1. The end of the metal lever arm 13 is consequently covered by a plastic layer 15. The plastic layer 15 also covers a side edge 16 that can abut against a bolt-shaped tappet 17. Again this achieves that noise stemming from different noise sources can be reduced by only one plastic layer 15.

The tappet 17 is mounted on a lever arm 18 of the main latching pawl covered with plastic. The main latching pawl is mainly hidden by preliminary latch pawl 2 in FIG. 1 and is consequently only partially visible. When the actual edge 16 of the preliminary latching pawl 2 abuts against the tappet 17, this causes the main latching pawl to be moved out of its latched position. Generally, the main latching pawl will, however, move out of its latching position automatically for the reasons known from published document DE 10 2007 003 948 A1 due to the application of an opening turning moment, as soon as the blocking lever 19 no longer blocks the main latching pawl because of a respective rotary movement.

As particularly loud noises can be generated when the arm 13 meets stop 14, it can be advantageous to also cover stop 14 with, for example, rubber to provide a particularly effective noise reduction.

In FIG. 1, the blocking lever 19 is moved around an axle by a pretensioned spring in clockwise direction, when the main latching pawl turns into the main latch. On its upper side the axle contains a circular stop 20a against which the blocking lever 19 is pressed by the force of the spring. The diameter of the circular stop is relatively large. This further improvement ensures a smooth operation. The diameter is, in particular, more than 1.5 times the size of the diameter of axle 20 (see FIG. 2), around which the blocking lever can be rotated.

The rotating movement of the blocking lever 19 is stopped as soon as the lever arm 21 strikes against stop 22. In order to minimize the noise of arm striking the stop, stop 22 consists of a metal bolt covered by a rubber coating.

The components of a motor vehicle door lock shown in FIG. 1 are arranged on a lock plate in the manner described in patent applications WO 2009/150225 A2 and DE 102009026920.7. These two patent applications disclose further details about the functioning and advantages of a motor vehicle door lock, containing components as shown in FIG. 1. We are respectively including the disclosure content of these two patent applications in this application.

FIG. 2 shows the components of FIG. 1 from the other side. The preliminary latching pawl 2 is therefore only partially hidden by the main latching pawl 23. The figure shows how the lever arm 24 of the main latching pawl 23 locks the rotary latch 1, so that it can not be turned to the open position (in case of FIG. 2 in anti-clockwise direction). Although the rotary latch exerts, for instance, an opening turning moment onto the main latching pawl as a result of a pretensioned spring acting accordingly on rotary latch 1, the lever arm 25 of the blocking lever 19 does, however, prevent the main latching pawl 23 from being pushed out of its latching position in the shown main latching position.

The main latch pawl 23 is rotatably mounted on said axle 4 around which also the preliminary latching pawl 2 can be rotated. A metal area of the main latching pawl 23 closely surrounds the metal axle 4 in contrast to the mounting of the preliminary latching pawl, which contains a plastic sleeve, as described. There is therefore for instance no plastic sleeve or covering between axle 4 and the adjacent metal area of the main latching pawl 23. The result is a rigid, movement-free connection to the rotary latch 1, which is advantageous for the desired closing of a respective door or tailgate.

The blocking lever 19 in turn is mounted differently and resiliently in contrast to the preliminary latch and main latch pawl. The pawl is pressed against the stop along axle 20 by an elastic element. The elastic element consists of three plastic springs 26, 27 and 28, attached to a plastic sleeve. The plastic sleeve separates the axle 20 from the metal area of the blocking lever 19. The springs 26, 27 and 28 are then located between the lock plate (not shown) and the adjacent underside of the blocking lever 19. Relative to the lock plate springs 26, 27 and 28 extend diagonally upwards towards the blocking lever, pressing the blocking lever resiliently against the stop 20 shown in FIG. 1 along axle 20. In a load-free state, springs 26, 27 and 28 together with the lock plate enclose a 20° angle.

In addition, three plastic surface elements 29, 30, 31 protrude perpendicularly from the sleeve, separating axle 20 from the metal area of the blocking lever 19 and contribute to separating the metal blocking lever from the metal lock plate in order to minimize noise and frictional losses. It was found that, in particular, the described elastic mounting of the blocking lever successfully contributes to minimize noise as a result of a smooth operation.

FIG. 3 provides a perspective and enlarged partial view of the resilient mounting of the blocking lever. FIG. 3 also shows a partial view of the lever arm 24, latching the rotary latch with the plastic-covered collecting arm 32 of the rotary latch.

Both lever arms 21 and 33 of the blocking lever 19 mainly extend in opposite directions when viewed from the axle 20. The center of gravity of the blocking levers is therefore close to its rotation axle 20.

The characteristics of the example embodiment do not have to be combined to achieve the described advantageous effect. The subject of claim 1 can therefore include single or different combinations of characteristics of the example embodiment.

### LIST OF REFERENCE NUMBERS

1 rotary latch
2 preliminary latching pawl
3 axle
4 axle
5 bolt
6 edge of the preliminary latching pawl
7 metal core
8 plastic casing
9 plastic coating
10, 11, 12 ribbon-shaped plastic areas
13 lever arm
14 stop
15 plastic layer
16 edge
17 tappet
18 lever arm
19 blocking lever
20 axle
20a stop
21 lever arm
22 stop
23 main latching pawl
24 lever arm
25 lever arm
26, 27, 28 springs
29, 30, 31 plastic surface elements
32 collecting arm
33 lever arm

1. A lock for a motor vehicle having a locking mechanism arranged on a lock plate, comprising a rotary latch, a main latching pawl and in particular a preliminary latching pawl for latching the rotary latch and a blocking lever, blocking the main latching pawl in the main latching position of the locking mechanism, wherein the blocking lever is preferably resiliently mounted.

2. The lock according to claim 1, wherein it is designed in such a way that in the main latching position the rotary latch produces an opening turning moment on the main latching pawl and/or that the blocking lever contains at least two lever arms, extending mainly in opposite directions when viewed from the rotation axle of the blocking lever.

3. The lock according to claim 1, wherein die preliminary latching pawl and/or the main latching pawl are not resiliently mounted.

4. The lock according to claim 1, wherein a plastic sleeve or covering separates the axle for the preliminary latching pawl from a metal area of the preliminary latching pawl.

5. The lock according to claim 1, wherein a metal area of the main latching pawl is immediately adjacent to the metal axle, around which the main latching pawl can be rotated.

6. The lock according to claim 1, wherein a plastic sleeve separates a metal area of the blocking lever from its metal axle.

7. The lock according to claim 1, wherein resilient elements resiliently press the blocking lever against a stop of the axle around which the blocking lever can be rotated.

8. The lock according to claim 7, wherein the diameter of the stop is at least 1.5 times the diameter of the axle around which the blocking lever can be turned.

9. The lock according to claim 1, wherein the preliminary latch of the rotary latch is formed by a protruding bolt, which in the preliminary latching position rests against the edge of the preliminary latching pawl, with the edge being formed by a metal core covered by a plastic layer.

10. The lock according to claim 9, wherein the plastic layer extends up to a bolt mounted on the preliminary latching pawl, whose metal core is covered by a plastic layer, with the bolt being part of a closing aid.

11. The lock according to claim 1, wherein an end area of a lever arm of the preliminary latching pawl is covered by a plastic layer, abutting against a stop.

12. The lock according to claim 1, containing a stop with a resilient surface for the preliminary latching pawl.

13. The lock according to claim 1, containing a stop with an elastic surface for the blocking lever.
